(19) United States
(12) Patent Application Publication
(10) Pub. No.: US 2014/0193550 A1
(43) Pub. Date: Jul. 10, 2014

(54) Egg Yolk Separator Device and Method

(71) Applicant: Junli Wang, Bolingbrook, IL (US)

(72) Inventor: Junli Wang, Bolingbrook, IL (US)

(21) Appl. No.: 13/736,987

(22) Filed: Jan. 9, 2013

(51) Int. Cl. A47J 43/14

(52) U.S. Cl. CPC A47J 43/14
USPC 426/298; 99/499

(57) ABSTRACT

An egg yolk separator device comprises uniquely configured structures for selectively grabbing an egg yolk from an egg albumen as supported upon a surface. A suction bulb and a tubular structure coupled to the suction bulb enable a user to selectively provide a suction force directed away from the inlet-outlet orifice toward the suction bulb for directing an egg yolk into the tubular structure. The orifice is sized and shaped to receive an egg yolk having a yolk weight, and the selectively provided suction force is greater than the yolk weight for directing the egg yolk into the yolk-receiving structure via the yolk inlet-outlet orifice. The tubular structure may further include a belly compartment that may house the egg yolk for further or later deposition and the bulb may further include a flattened side for preventing rotation of the device and maintaining the belly compartment in a downwardly extended direction.

### BACKGROUND OF THE INVENTION

1. Field of the Invention

The present invention relates generally to a device for separating an egg yolk from an egg albumen. More particularly, the present invention relates to device for vacuuming an egg yolk structure from the surrounding albumen of egg shell contents once the contents are removed from the egg shell.

2. Brief Description of the Prior Art

With the increase in further processing of eggs, structural integrity of the vitelline or yolk membrane has become an increasingly important issue for the egg breaking industry. Statistical reports state that over 750 million kilograms of liquid egg products are produced each year for use in the food service, commercial egg products, and as ingredients in other food products. Egg albumen is a particularly important ingredient in many baking processes and in the preparation of various confections. Slight contamination of the albumen with yolk, however, can alter protein functionality and negatively affect certain properties of the albumen.

Further, recent trends in dietary improvements have influenced many individuals to take more proactive steps to removing the yolk from the albumen when consuming egg products. Accordingly, successful separation of the yolk from the albumen has become extremely important not only in the food industry. Certain devices, methods, and machinery used for the removal or separation of egg yolk from egg albumen have been developed as means to address this need. Brief descriptions of some of the more pertinent egg separating means known in the art are set forth hereinafter.

U.S. Pat. No. 3,857,327 ('327 patent), issued to Popeil, disclosed a Double Egg Separator. The '327 patent describes a double egg separator having a pair of yolk cups positioned centrally of two drain areas defined by steep drain walls separated by a vertical wall which serves as an egg cracker. Each of the yolk cups is surrounded by opposed crescent-shaped drain slots. Preferably, the yolk cup has a drain hole at its lower portion, and is provided with a pebbled texture surface. Around the periphery of the unit a support rim is provided terminating at opposed diametrical ends in support ears which permits the egg separator to be positioned atop varying diameter mixing bowls.

A support rim depends from the support skirt, and also a stand ring is provided below and outside of the yolk cup so that the egg separator may be positioned on a counter top after the yolks are separated from the egg and prior to using the yolk. One of the support ears may be perforated for use in hanging the same on a hook or other convenient storage medium. In a preferred embodiment, a drain guide is provided at the outer reaches of the crescent-shaped drain slot to assist in accelerating the passage of the egg whites, and to terminate such drainage with a minimum of dripping.

U.S. Pat. No. 4,137,837 ('837 patent) and U.S. Pat. No. 4,137,838 ('838 patent), issued to Warren, disclose certain Means for Breaking and Separating Eggs. The '837 and '838 patents describe an improved separator methodology whereby an egg is cracked and opened and drained into a separator cup. The yolk is supported in an imperforate cup over a substantial portion of its under surface and the surrounding egg white is drained from the yolk into a separate pan through an elongated generally spiral or curving opening in a support member extending upwardly from the yolk support cup. The white collecting pan is positioned to receive the egg white below the yolk cup.

U.S. Pat. No. 4,919,042 ('042 patent), issued to Rasmussen, discloses an Apparatus for the breaking of eggs and their separation into yolk and albumen. In an apparatus for the breaking of eggs and separation of yolk and albumen, and of the kind comprising a supply conveyor, a washing and flushing system and a breaking mechanism positioned at one end of the conveyor and having a considerable number of egg stations each capable of receiving and holding one egg at the time, and with separate containers of yolk and albumen, the eggs stations are arranged for successively passing the conveyor to receive eggs and continue through a closed path along which working stations are provided for control of the separation of yolk and albumen, their collection in separate ducts or containers and removal of empty egg shells. A working station for removal of shells comprises a valve-controlled compressed air supply for blowing off the shells from shell holder means in each egg station, and a conical scavenging duct for reception and removal of the off-blown egg shells, said duct being combined with an air sluice and means to provide a sub pressure for secure removal of residual albumen.

U.S. Pat. No. 5,069,119 ('119 patent), issued to Idowu, discloses an Egg Separator. The egg separator according to the '119 patent comprises a cup-shaped member in an upper portion of a unitary housing for receiving an egg, retaining the yolk and allowing the albumen to overflow the cup-shaped member through surrounding slots into a first chamber in the housing, a lever being operable thereafter to break the yolk and form an opening in the cup-shaped member for allowing the yoke to flow through a tube extending downwardly through the first chamber into a second chamber. The chambers each have inclined floors and chutes for allowing their respective contents to flow into separate containers. A funnel is preferably mounted above the cup-shaped member together with an anvil so that the shell of the egg can be broken on the anvil and the combined yolk and albumen directed into the cup-shaped member by the funnel.

U.S. Pat. No. 5,527,550 ('550 patent), issued to Miles et al., discloses an Egg Yolk Extracting Method. The '550 patent describes an egg yolk extractor device and method removes up to about 90% of the yolk of an egg in such a way that the remaining yolk and white each retain their integrity and appearance when removed from the extractor device. A freshly cracked egg is placed onto the extractor with the yolk in a central area which generally confines the yolk but lets the white migrate outwardly. Vacuum is applied beneath the yolk via a small hole which breaks the yolk membrane and draws out most of the yolk but tends to retain the membrane together such that the remaining yolk retains its integrity in the membrane.

U.S. Pat. No. 5,628,246, issued to Kristensen, discloses an Egg Processing Machine. The '246 patent describes an egg processing machine comprises egg breaking units positioned above egg collecting units and an albumen recovery device. The units are moved in pairs with a vertical distance between the two units through an egg breaking section where the egg breaking unit breaks the egg shell and albumen and yolk fall down in the egg collecting unit. An albumen recovery device comprises a rotating body catching albumen drippings with possible stringers before the egg shell is discharged.

U.S. Pat. No. 6,095,038, issued to Cerro, discloses an Egg White and Yolk Separator. The '038 patent describes an egg white and yolk separator for separating the egg yolk from the egg white of a broken egg shell of a whole egg. The egg white and yolk separator includes an egg yolk collector for collecting and holding a plurality of egg yolks therein, the collector having an upper surface with a plurality of spaced-apart, concave-shaped compartments formed in the upper surface for holding the yolks and egg whites of a whole egg, wherein each of the compartments includes a slit opening located at the bottom of each of the compartments for draining of egg whites through the slit openings. The egg white and yolk separator also includes an egg white receiving container under the collector for collecting egg whites drained from the slit openings in each of the compartments. The egg yolk collector further includes an egg shell breaking bar for breaking the egg shell of an egg to remove the contents of the egg into one of the concave-shaped compartments of the egg yolk collector, and an egg shell collection compartment for collecting egg shells of the broken eggs.

U.S. Pat. No. 6,135,017, issued to Wang et al., discloses a Wire Egg Separator. The '017 patent describes an egg separator made from a length of wire which has been bent and twisted to form a cup-shaped portion in which the white of the egg is separated from the yolk of the egg. The separator also includes a handle having two wire arms with bends therein defining slots which together define a clip which allows the egg separator to be rested to the rim of a bowl. The bends include arms which may be inclined at an angle relative to the handle corresponding generally to the angle at which the wall of the bowl is inclined so that the cup-shaped portion remains level in the bowl.

U.S. Pat. No. 6,915,735 ('735 patent), issued to So, discloses an Egg Yolk Separator. The '735 patent describes an egg yolk separator comprising a strainer having a portion for retaining an egg yolk and apertures for straining egg white. A pair of arms extends in opposite directions from the strainer for resting on opposite sides of an opening of a vessel, locating the separator on the vessel. One of the arms is extendable and retractable in length such that overall length of the separator is adjustable to suit the width of the opening of the vessel.

U.S. Pat. No. 7,472,647 (See also United States Patent Application Publication No. 20070101871), issued to Patterson describes an egg separator device having an upper elongated slit to prevent the yolk of an egg from entering a collection device for egg whites. The device provides for a method that will allow multiple separations of egg whites from egg yolks upon cracking individual eggs. The presence of an upper elongated slit in the concave compartments of the device allows the egg white of the eggs to separate from the egg yolks without the egg yolk entering a collection device and/or mixing, merging or flowing into the collected egg whites.

United States Patent Application Publication No. 20110041710, authored by Collins, describes a centrifugal egg separator that has a plurality of user-selectable discrete rotational speeds for performing a corresponding plurality of egg separation operations. Up to two speeds may correspond to centrifugal egg breaking: one for separating yolk and albumin from shell and chalazae and one for separating yolk, albumin, and chalazae from shell. Up to three speeds may correspond to separating components of broken eggs: one for separating out only albumin, one for separating out the yolk and albumin, and one for separating out the yolk, albumin, and chalazae.

It will be seen from a review of the foregoing in particular, and the field of egg separating means in general that the prior art perceives a need for an egg yolk separator device comprising first and second ends whereby the first end comprises an elastomeric suction bulb and the second end comprises a substantially rigid, yolk-receiving chamber having a yolk-housing belly for supporting the yolk once vacuumed into the device via suction action of the suction bulb and yolk-receiving chamber. Accordingly, the present invention provides an egg yolk-separating device of the foregoing type as summarized in more detail hereinafter.

### SUMMARY OF THE INVENTION

The present invention essentially provides a device for grabbing an egg yolk and/or separating an egg yolk from egg albumen. The device according to the present invention is believed to essentially comprise certain suction means for selectively providing a suction force; and a yolk-receiving structure.

The yolk-receiving structure essentially comprises an inlet-outlet orifice, and is coupled to said suction means such that the selectively provided suction force is directed away from the inlet-outlet orifice toward the suction means. The inlet-outlet orifice is sized and shaped to receive an egg yolk having a yolk weight, the suction force being greater than the yolk weight for directing the egg yolk into the yolk-receiving structure via the yolk inlet-outlet orifice.

The suction means may be preferably defined by a suction bulb having a main body and a band structure. The band structure preferably has a relatively higher spring constant as compared to the main body for providing the user with certain means for selectively differing the applied suction force upon the egg yolk. The suction bulb may further preferably comprise a flattened outer surface, which flattened outer surface extends in a plane parallel to the tubular or cylindrical axis and orthogonal to the radial direction of the yolk-receiving chamber.

In this last regard, the yolk-receiving structure of the device according to the present invention may notably comprise an inner yolk-receiving chamber or belly compartment, which yolk-receiving chamber extends radially from the cylindrical axis for receiving and supporting the egg yolk in radial adjacency to the cylindrical axis. The maximum inner diameter of the belly compartment is roughly twice the diameter of the inlet-outlet orifice so as to radially compartmentalize the received egg yolk in radial adjacency to the cylindrical or tubular axis.

The inlet-outlet orifice comprises a rounded outer terminus and a cylindrical inner surface. Together the rounded outer terminus and cylindrical inner surface reduce stress on the vitelline membrane for preventing inadvertent rupture of the egg yolk during a grabbing and/or lifting event. The yolk-receiving chamber preferably comprises a smooth surface coextensive with the cylindrical inner surface thereby together forming smooth inner yolk displacement surfacing for preventing rupture of the vitelline membrane during egg yolk displacements.

In addition to the various structural aspects of the invention, it is believed that the specifications set forth hereinafter further support certain egg moving methodological advancements or certain methods for moving an egg yolk. Accordingly, the method for moving an egg supported by the device according to the present invention is believed to essentially comprise the steps of: sucking an egg yolk into an egg-receiving structure via a suction force in a first direction away from a first location; and displacing the egg-receiving structure with the egg yolk contained therein to a second location.

The method may further comprise the step of directing the egg yolk in a second direction within the egg-receiving structure after sucking the egg yolk into the egg-receiving structure in the first direction. The step of directing the egg yolk in the second direction within the egg-receiving structure may be defined by comprising the step of chamber-receiving the egg yolk in a direction radial to the first direction. The step of directing the egg yolk in the second direction may preferably comprise the step of gravitationally forcing the egg yolk in the direction radial to the first direction.

### BRIEF DESCRIPTION OF THE DRAWINGS

Other features of our invention will become more evident from a consideration of the following brief descriptions of illustrations of the subject invention:

FIG. 1 is a bottom or ventral perspective view of the egg yolk separator device according to the present invention.

FIG. 2 is a top or dorsal plan view of the egg yolk separator device according to the present invention.

FIG. 3 is a first side or lateral elevational view of the egg yolk separator device according to the present invention.

FIG. 3(a) is a first or orifice end view of the egg yolk separator device according to the present invention.

FIG. 3(b) is a second or bulb end view of the egg yolk separator device according to the present invention.

FIG. 4 is a bottom or ventral plan view of the egg yolk separator device according to the present invention.

FIG. 5 is a second side or lateral elevational view of the egg yolk separator device according to the present invention.

FIG. 6 is a first sequential diagrammatic depiction of the egg yolk separator device according to the present invention being compressed at the bulb end for elastically actuating the bulb end of the egg yolk separator device prior to engaging an egg yolk.

FIG. 7 is a second sequential diagrammatic depiction of the egg yolk separator device according to the present invention being elastically restored at the bulb end for directing an egg yolk into the egg yolk separator device with a suction force.

FIG. 8 is a third sequential diagrammatic depiction of the egg yolk separator device according to the present invention housing an egg yolk within an internal egg-yolk receiving compartment or belly.

FIG. 9 is a perspective view of the egg yolk separator device in an assembled state.

FIG. 10 is an exploded perspective view of the egg yolk separator device otherwise depicted in FIG. 9.

FIG. 11 is a longitudinal cross-sectional view of the egg yolk separator device according to the present invention.

FIG. 12 is a lateral view of the egg yolk separator device showing the device supported by an underlying surface, a flattened bulb end of the device preventing the device from rolling.

FIG. 13 is a bulb end view of the egg yolk separator device showing the device supported by an underlying surface, the flattened bulb end of the device preventing the device from rolling.

FIG. 14 is an orifice end view of the egg yolk separator device showing various relative diametrical dimensions of the egg yolk separator device.

FIG. 15 is a diagrammatic depiction of the diametrical dimensions of certain inner surfacing of the tubular construction and belly compartment of the egg yolk separator device.

FIG. 16 is a longitudinal cross-sectional depiction of an avian egg.

FIG. 17 is a depiction of an avian egg being broken for spilling the egg shell contents upon a contents-support surface.

FIG. 18 is a diagrammatic depiction of an orifice end of the egg yolk separator device positioned in superior adjacency to a surface-supported egg.

FIG. 19 is a diagrammatic depiction of a fragmentary suction bulb construction being elastically restored for forcing an egg yolk into the orifice end of the egg yolk separator device.

FIG. 19(a) is a fragmentary, enlarged diagrammatic depiction of a vitelline membrane of the egg yolk otherwise depicted in FIG. 19 depicting tensile forces within the vitelline membrane.

FIG. 20 is a diagrammatic depiction of the egg yolk separator device according to the present invention being oriented in a vertical direction for directing a compartment-received egg yolk in a downward direction for deposition within an egg-yolk container.

FIG. 21 is a diagrammatic depiction of a fragmentary suction bulb being elastically actuated to force an egg yolk through a fragmentary orifice end of the egg yolk separator device.

FIG. 22 is a diagrammatic depiction of a fragmentary suction bulb being elastically restored while a released egg yolk is directed under its weight in a downward direction.

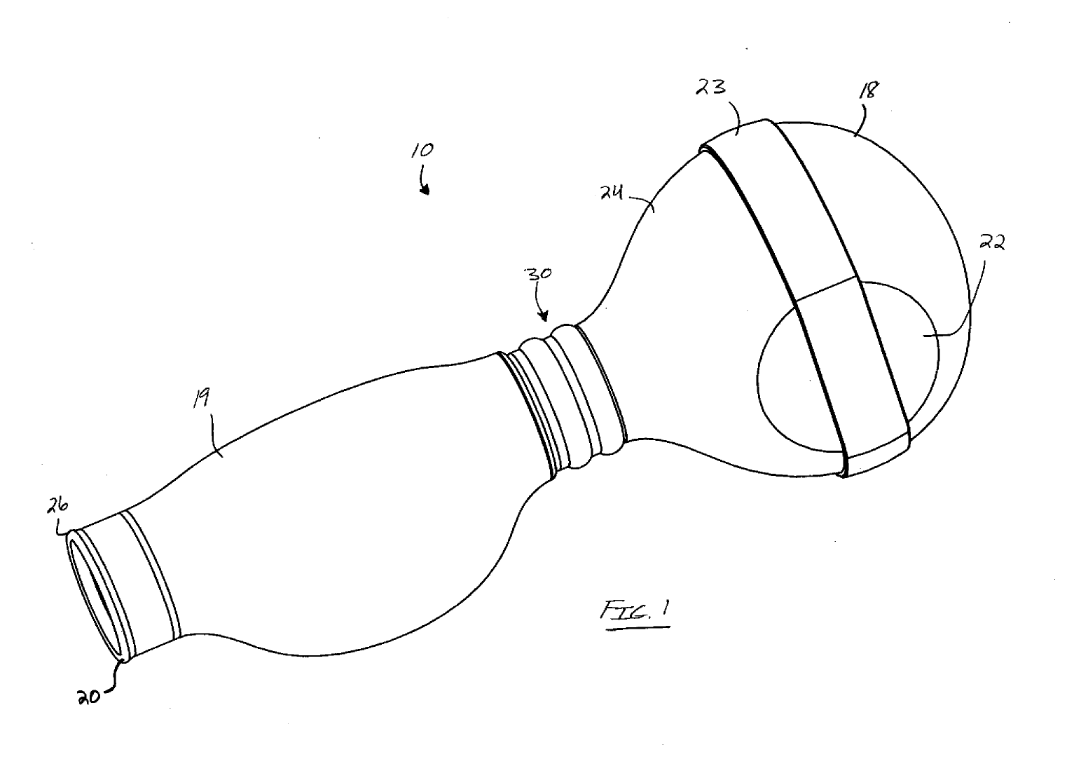

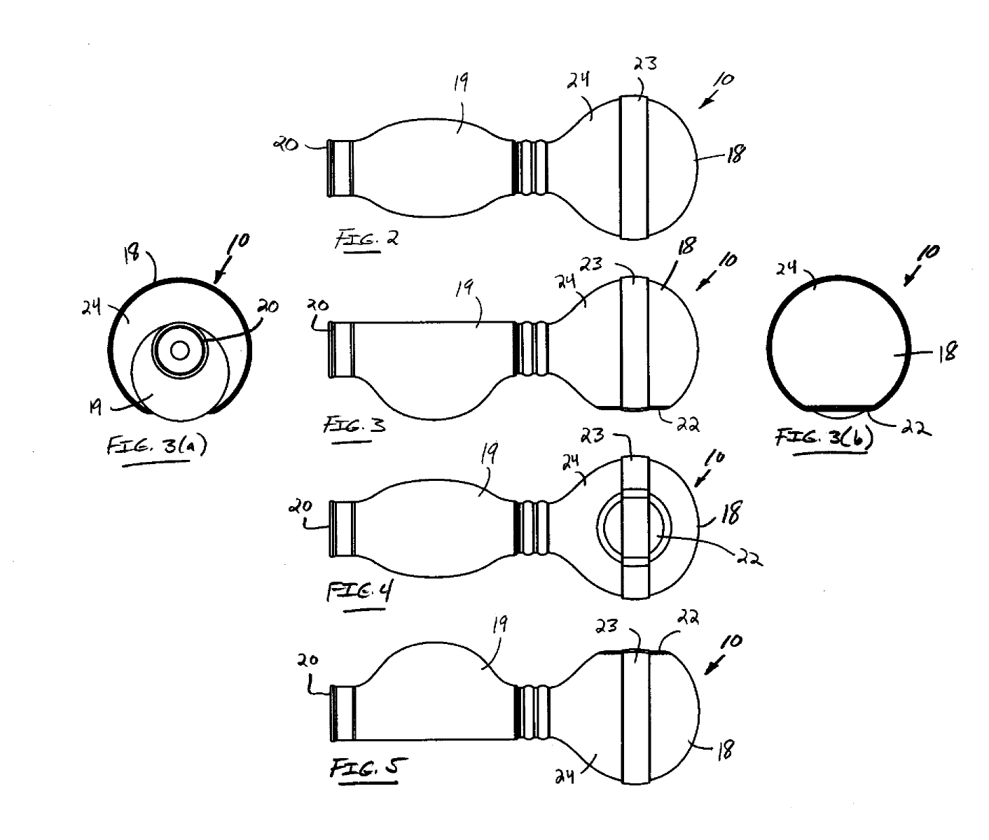

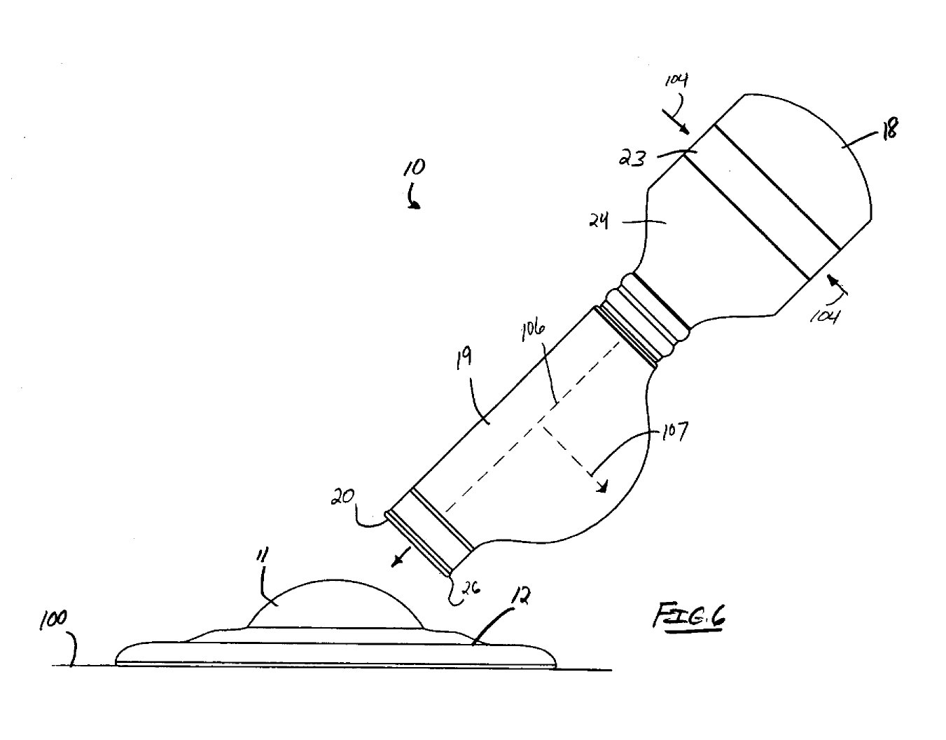

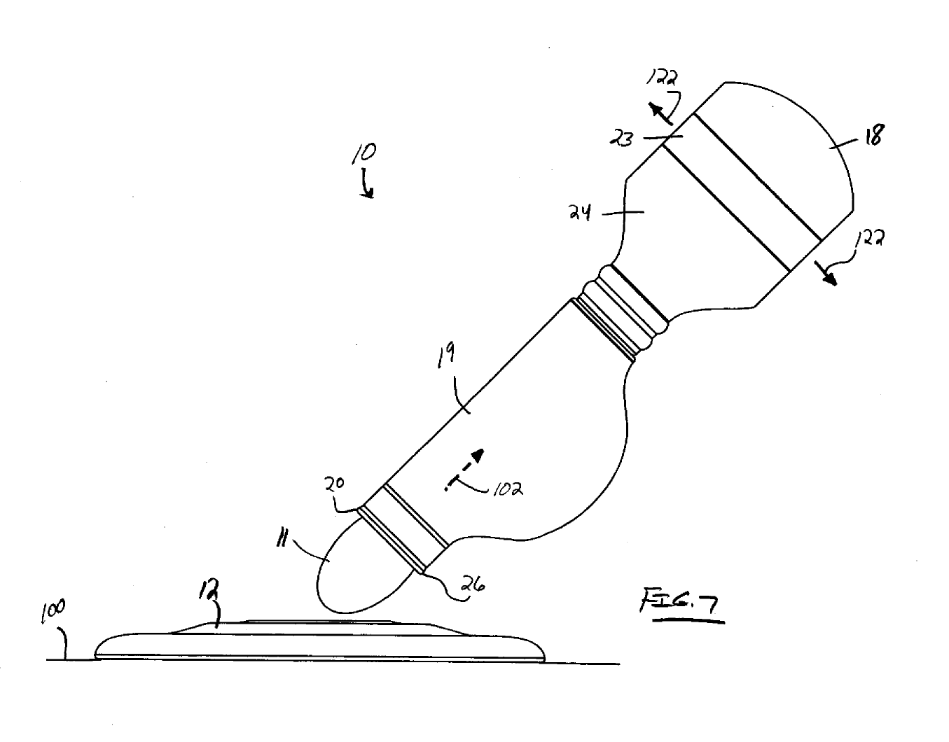

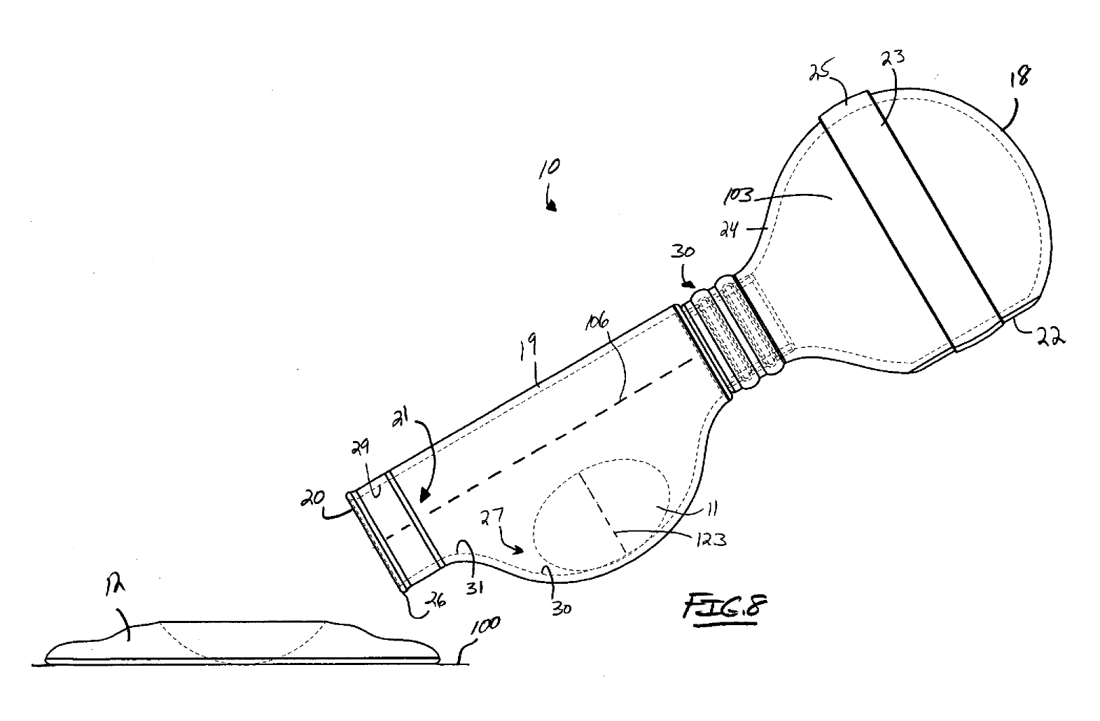

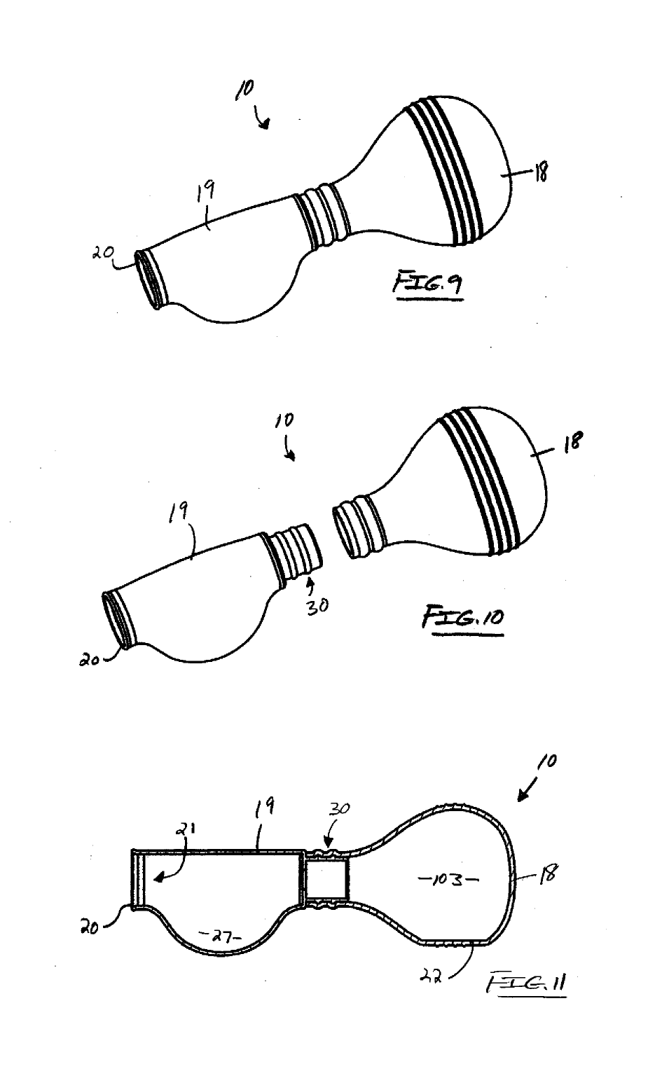

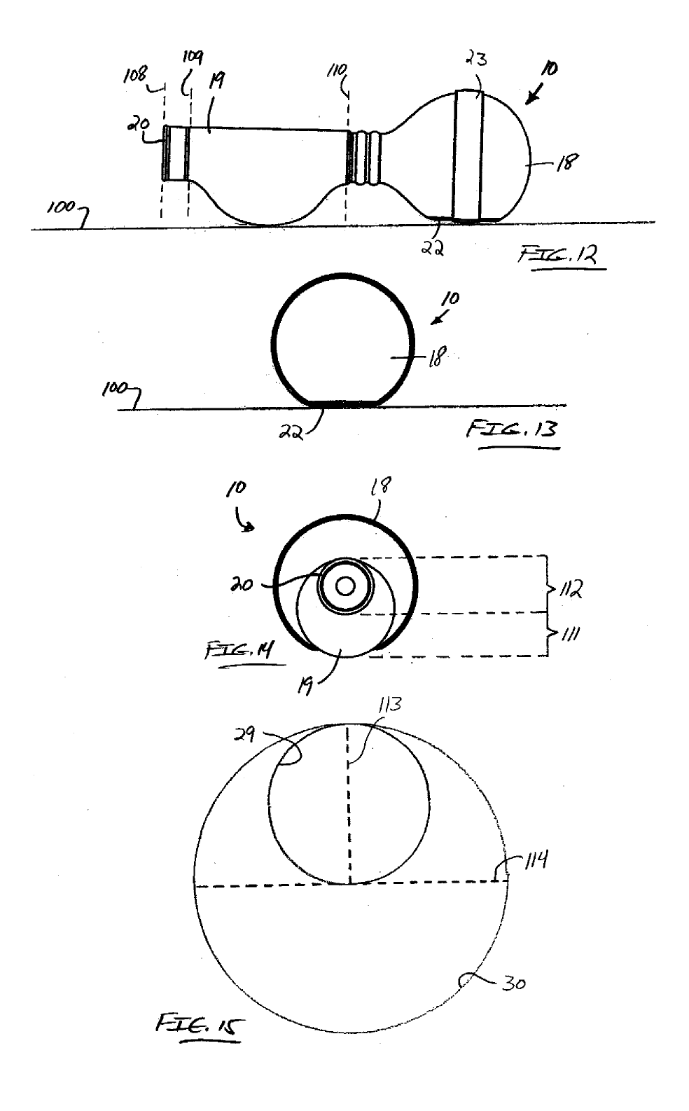

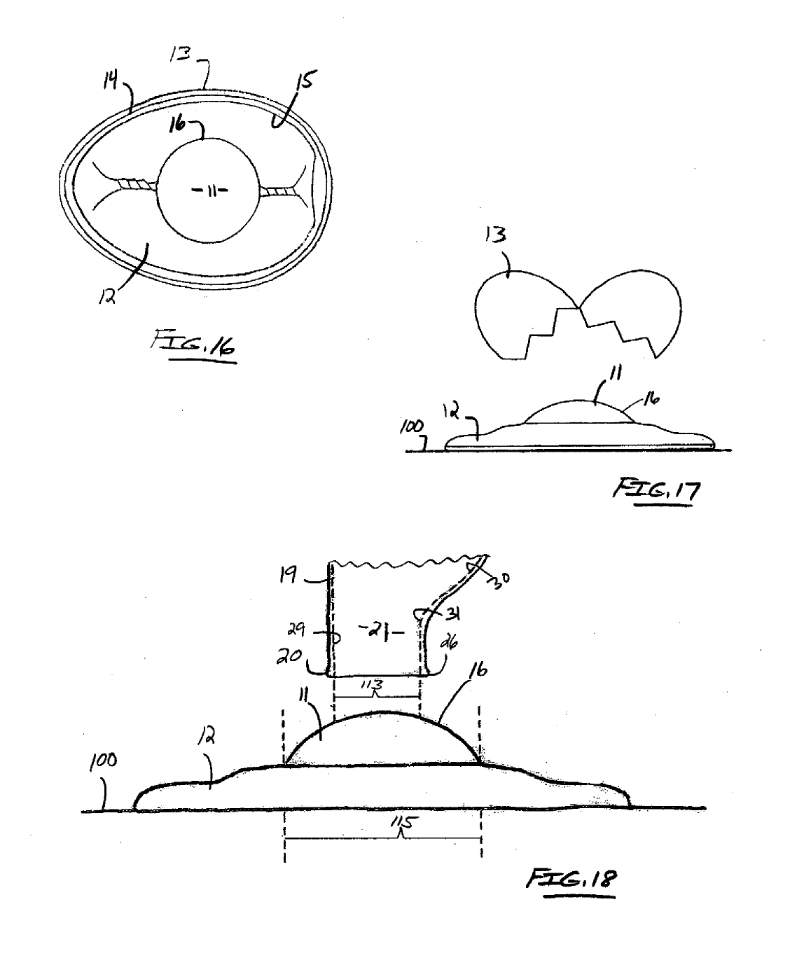

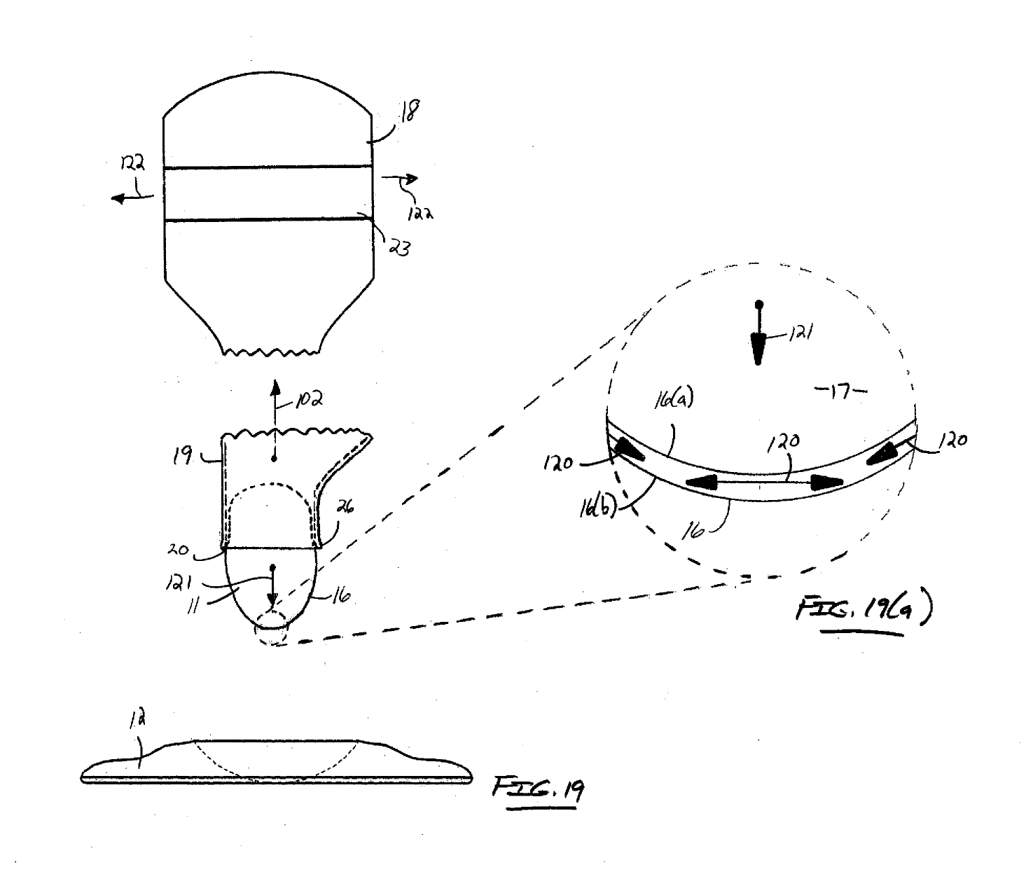

### DETAILED DESCRIPTION OF THE PREFERRED EMBODIMENT AND METHODOLOGY

The primary evolutionary function of the avian egg is as a vehicle for avian reproduction. However, the avian egg also importantly serves as a source of food for human consumption. While eggs contain only a trace amount of carbohydrate, they offer a good source of protein. Some egg enthusiasts do find some complaint with egg nutrition, however, insofar as they contain relatively high levels of cholesterol and saturated fat, most particularly in the egg yolk.

A large egg yolk contains approximately 55 calories in roughly one tablespoon of volume, while an egg white contains just 16 calories in roughly two tablespoons of volume. Further, almost all of the 5 grams of fat in a large egg is contained within the yolk, with just trace amounts of fat found in the egg white. An egg yolk contains all 2 g of an egg's saturated fat and all 210 milligrams of cholesterol. Accordingly, many egg consumers prefer to separate out the egg yolk prior to egg consumption as a means to limit their intake of certain unwanted dietary elements.

In an effort to provide the egg consumer with a more efficient means of separating the egg yolk from the egg white, the present invention is provided. Referring to the drawings with more specificity, the preferred embodiment of the present invention provides an egg yolk separator device 10 for enabling egg-consuming humans to separate the egg yolk 11 from the egg albumen or egg white 12 of egg shell contents once the cytoplasmic egg shell contents are deposited upon a(n egg) contents-support surface as at 100.

The size and shape of avian eggs differ among the various species of birds, but all eggs have three main parts, namely, an egg yolk as at 11, an egg albumen as at 12, and an egg shell as at 13. These three parts of the egg are separated from each other by membranes. The egg shell 13 is separated from the egg albumen 12 by the outer and inner shell membrane(s) as at 14 and 15 respectively, and the egg yolk 11 is separated from the egg albumen 12 by the yolk membrane or vitelline membrane as at 16.

The tensile strength (as diagrammatically depicted at arrows 120) of the vitelline membrane 16 is of particular importance to the practice of the present invention since a normal or typical vitelline membrane 16 will have sufficient membrane strength to hold the yolk contents 17 within the membrane 16 during a yolk lifting event as generally depicted in FIGS. 7 and 19. The yolk 11 of a freshly laid egg is round and firm and typically effects a pronounced rounded or hemispherical shape when deposited upon a surface as at 100.

As the egg yolk 11 ages, it absorbs water from the egg albumen 12 and slowly increases in size, while the tensile strength of the vitelline membrane 16 slowly weakens. The vitelline membrane 16 gives the egg yolk 11 a somewhat flattened shape on top and a general “out-of-round” shape as the vitelline membrane 16 weakens. The tensile strength 120 of the vitelline membrane 16 inherently stems from a transparent fibrous bi-layer which encloses the egg yolk 11.

The inner layer 16(a) (lamina perivitellina) of the bi-layer is laid down around the egg yolk 11 while it is still in the ovary, whilst the outer layer 16(b) (lamina exravitellina) is added after ovulation as the egg yolk 11 passes down the oviduct. In the inner layer 16(a) there are at least four different glycoproteins. The outer layer 16(b) consists mainly of lysozyme, ovomycin, lectin and certain other proteins.

The strength and elasticity of the vitelline membrane 16 is important for both food safety and product quality concerns. The strength of the membrane 16 has been associated with the ability of microorganisms to enter the nutrient rich yolk, for example. Also, contamination of commercially prepared albumen 12 with yolk 11 during separation can lead to greatly diminished albumen functionality.

One study showed that the strength of the fresh yolk vitelline membrane 16 is typically on the order of 450 grams as determined by way of a Texture Analyzer while weighing roughly 15 grams. The reader will thus see that the tensile strength 120 of the vitelline membrane 16 is sufficient to act as a cargo net of sorts as the cytoplasmic egg yolk contents 17 are lifted thereby.

Notably, the prior art devices that essentially operate by centralizing a yolk-receiving compartment while providing for egg albumen outlets radially adjacent the centralized compartment indirectly incorporate or utilize the inherent vitelline membrane strength to separate the egg albumen 12 from the egg yolk 11. The prior art devices basically attempt to isolate the physical boundary of the vitelline membrane 16 in radial adjacency to the egg yolk 11 while allowing the albumen 12 to fall away from the yolk 11.

The present invention, however, relies more heavily or directly upon the inherent characteristics of the naturally occurring vitelline membrane strength to enable the user to separate the egg yolk 11 from the egg albumen 12 by lifting the egg yolk 11 from the egg albumen 12 under a suction force effected by way of certain suction means or pressure differential. Notably, the prior art does show another device that operates to separate egg yolk 11 via certain suction means. In the case of the device and method taught by U.S. Pat. No. 5,527,550, the vitelline membrane 16 is ruptured at a point, however. The '550 patent teaches a vacuum implement insertable through the rupture site to uptake the fluid cytoplasm or egg yolk contents via the ruptured membrane 16.

None of the prior art appears to teach a device that functions by suctioning or vacuuming the entire intact vitelline membrane 16 with its fluidic cytoplasmic egg yolk contents 17 into a yolk-receiving compartment in an upward direction away from an otherwise surface-supported egg albumen 12. Because the egg-yolk lifting event does not rupture of damage the vitelline membrane 16 according to the present invention, the egg yolk 11 can then be carried and/or further deposited into a secondary container (as at 101) or similar other disposal mechanism intact and whole.

In this last regard, the device 10 according to the present invention can be used to deposit or place the egg yolk 11 in virtually any location by allowing the egg yolk 11 to re-direct as at 119 under gravitational force or yolk weight as at 121 and/or by forcing the egg yolk out the inlet-outlet orifice 20 by compressing the suction bulb 18 and creating a yolk-expulsive pressure or force 105 behind the egg yolk 11 as it travels down the canal or pathway 21 of the presently described egg yolk separator device 10.

The egg yolk separator device 10 according to the present invention thus may be said to essentially function for separating an intact egg yolk 11 from egg albumen 12. To achieve this and other readily apparent objectives, the egg yolk separator device 10 according to the present invention preferably comprises (1) certain suction means as preferably exemplified by a suction bulb 18 for selectively providing a suction force as at arrow 102; and (2) a yolk-receiving structure or construction as at 19 for receiving and structurally directing an egg yolk 11 under the suction force 102. Alternative suction means may exemplified by syringe type plunger type arrangements not specifically illustrated.

The suction bulb 18 is preferably constructed from elastomeric material(s) and defines a (bulb-relaxed) inner volumetric space as at 103. The suction bulb 18 is (radially) compressible (as at arrows 104) to an actuated state for decreasing the inner volumetric space 103 and elastically restorable (as at arrows 122) to a relaxed state for re-defining the inner volumetric space 103. The elastic restorabililty of the suction bulb 18 essentially functions to selectively create the suction force 105 for directing the egg yolk 11 into the yolk-receiving structure 19 via the yolk inlet-outlet orifice 20.

The suction bulb 18 further preferably comprises a circumferential elastomeric band structure as at 23. The circumferential elastomeric band structure 23 may comprise a first elastomeric material and the suction bulb main body 24 may comprise a second elastomeric material, whereby the first elastomeric material comprises a relatively higher spring constant than the second elastomeric material.

Alternatively, and perhaps preferably, the band structure 23 may be integrally formed to the main body 24 thereby increasing the thickness of the wall of the suction bulb 18 at the band site 25 thereby enhancing the spring constant at the band site 25 relative to the main body 24. The enhanced elastic restorability of the band structure 23 by virtue of the higher spring constant and/or thickened wall construction provides the user with certain means to selectively enhance the egg-lifting, suction force 102.

The yolk-receiving structure 19 preferably comprises a yolk inlet-outlet orifice as at 20. The yolk inlet-outlet orifice 20 preferably comprises a rounded outer terminus 26 for preventing inadvertent rupture of the egg yolk 11 as might otherwise occur with rough or sharpened edging at the terminus. The structure 19 further has a somewhat tubular construction preferably having a first series of substantially uniform circular transverse cross-sections from plane 108 to plane 109 (preferably about 2.2 cm inner diameter) and a second series of varying circular transverse cross-sections from plane 109 to plane 110.

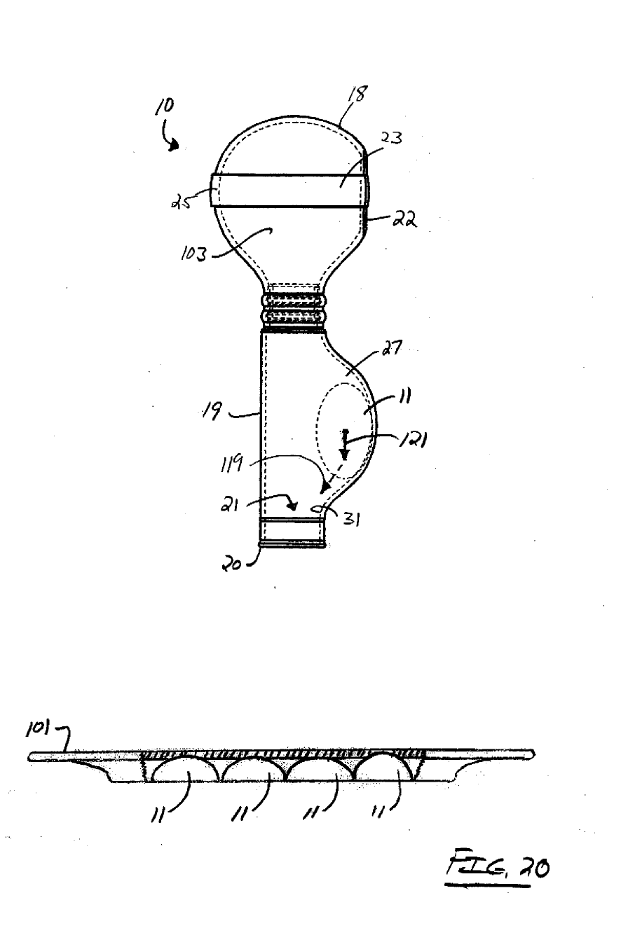

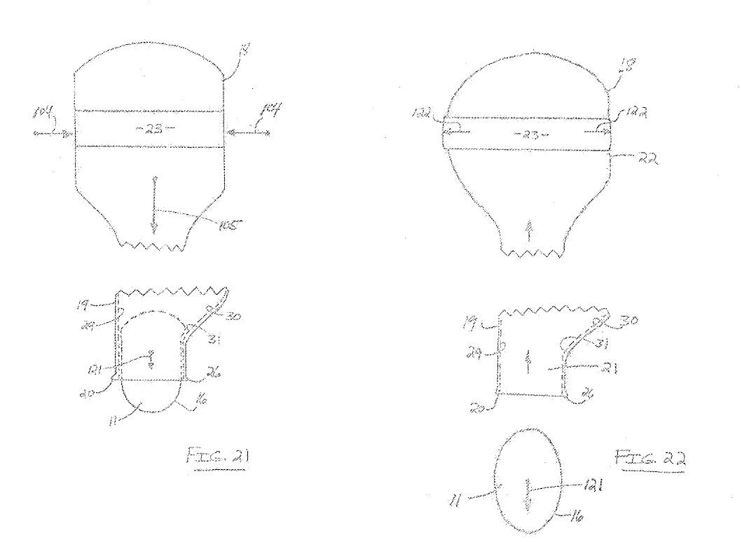

The inner diameter 113 of the tubular construction is preferably about 2.2 centimeters, which diameter 113 is lesser in magnitude than the outer diameter 115 of a surface supported egg yolk 11 as generally depicted in FIG. 18. When force 102 directs the egg yolk 11 into the tubular construction, the diameter 115 of egg yolk is compressed so as to substantially equal that of the inner diameter 113 of the tubular construction so that the force 102 may more effectively pull the egg yolk 11. An outer diameter of the tubular construction is depicted at 112, and an outer radius of the belly compartment 27 is depicted at 111, the radius 111 being roughly equivalent to the diameter 112.

The second series of varying circular transverse cross-sections of the structure 19 is designed to chamber-receive an egg yolk 11 under gravitational force and support the egg yolk 11 within a belly compartment 27 that extends in a (downward) direction 107 radial to the cylindrical axis 106 of the tubular construction (or direction orthogonal to the flattened side or outer surface 22 of the suction bulb 18). The egg yolk 11, as received in the belly compartment 27, assumes a more relaxed maximum diameter 123 that easily fits within an inner diameter 114 of the belly compartment 27.

Notably, the maximum diameter of region within planes 109-110 (preferably about 4.4 cm inner diameter as at 114) is roughly twice the diameter of the region between planes 108 and 109 (i.e. about 2.2 cm inner diameter as at 113). The yolk-receiving chamber or cavity or belly compartment 27 that extends from the cylindrical portion of the structure 19 between planes 109 and 110 enables the user to more confidently hold, carry and/or transfer the egg yolk 11 to various locations away from a first location; typically the site of egg shell breakage.

As mentioned above, the reader should further note that the suction bulb 18 preferably comprises a flattened side as at 22. The flattened side 22 is incorporated into the bulb design so as to prevent the device 10 from rolling, and to maintain the belly compartment 27 of the device 10 in an orientation such that the radial direction 107 points downward so that the compartment-received egg yolk 11 is maintained within the belly compartment 27 when the user places the device 10 upon a support surface 100.

It should be noted that as the suction force 102 directs the egg yolk 11 into the tubular structure, the egg yolk 11 conforms to the size and shape of the inner diameter 113 as it progresses through the tubular construction at the region between planes 108 and 109. Accordingly, the pressure differentials that force 102 the egg yolk 11 in the desired direction, and the natural lubricating action of the substances found upon a naturally occurring egg yolk 11 (e.g. albumen remnants), enable effective progression of the egg yolk 11 within the tubular construction as generally and comparatively depicted in FIGS. 7 and 19.

The yolk-receiving structure 19 is preferably removably and threadably coupled (threads being depicted and referenced at 30) to the suction bulb 18 such that the selectively provided suction force 102 is directed away from the yolk inlet-outlet orifice 20 toward the suction bulb 18. The removably and threadably coupled yolk-receiving structure 19 is made selectively removable for enabling interchangeability of components with the suction bulb 18 (e.g. it is contemplated that graduated measuring tubes or liquid basting tubes could be coupled to the suction bulb 18). The orifice 20 is preferably sized and shaped to receive an egg yolk 11 having a certain yolk weight as diagrammatically depicted at 121, a vitelline membrane 16, and membrane-contained yolk cytoplasm 17.

The suction force 102 enabled by way of the restorative forces as at arrows 122 inherent to the elastomeric suction bulb 18 is greater than the yolk weight 121 for directing the egg yolk 11 into the yolk-receiving structure 19 via the yolk inlet-outlet orifice 20. The yolk-receiving structure 19 preferably comprises a cylindrical inner surface 29, which surface 29 has a cylindrical axis as at 106. The cylindrical inner surface 29 reduces stress on the vitelline membrane 16 and thus basically functions to prevent inadvertent rupture of the egg yolk 11.

The egg yolk separator device 10 further preferably comprises an inner yolk-receiving chamber or belly compartment as at 27, which yolk-receiving chamber or belly compartment 27 extends radially from the cylindrical axis 106 for receiving and supporting the egg yolk 11 in radial adjacency to the cylindrical axis 106. The yolk-receiving chamber or belly compartment 27 preferably comprises a smooth surface 30 coextensive with the cylindrical inner surface 29 thereby together forming smooth inner yolk displacement surfacing 31 for preventing rupture of the vitelline membrane 16 during egg yolk displacements.

While the foregoing specifications set forth much specificity, the same should not be construed as setting forth limits to the invention but rather as setting forth certain preferred embodiments and features. For example, as prefaced hereinabove, it is contemplated that the present invention essentially provides a device for grabbing an egg yolk and/or separating an egg yolk from egg albumen. The device according to the present invention is believed to essentially comprise certain suction means for selectively providing a suction force; and a yolk-receiving structure.

The yolk-receiving structure essentially comprises an inlet-outlet orifice, and is coupled to said suction means such that the selectively provided suction force is directed away from the inlet-outlet orifice toward the suction means. The inlet-outlet orifice is sized and shaped to receive an egg yolk having a yolk weight, the suction force being greater than the yolk weight for directing the egg yolk into the yolk-receiving structure via the yolk inlet-outlet orifice.

The suction means may be preferably defined by a suction bulb having a main body and a band structure. The band structure preferably has a relatively higher spring constant as compared to the main body for providing the user with certain means for selectively differing the applied suction force upon the egg yolk. The suction bulb may further preferably comprise a flattened outer surface, which flattened outer surface extends in a plane parallel to the tubular or cylindrical axis and orthogonal to the radial direction of the yolk-receiving chamber.

In this last regard, the yolk-receiving structure of the device according to the present invention may notably comprise an inner yolk-receiving chamber or belly compartment, which yolk-receiving chamber extends radially from the cylindrical axis for receiving and supporting the egg yolk in radial adjacency to the cylindrical axis. The maximum inner diameter of the belly compartment is roughly twice the diameter of the inlet-outlet orifice so as to radially compartmentalize the received egg yolk in radial adjacency to the cylindrical or tubular axis.

The inlet-outlet orifice comprises a rounded outer terminus and a cylindrical inner surface. Together the rounded outer terminus and cylindrical inner surface reduce stress on the vitelline membrane for preventing inadvertent rupture of the egg yolk during a grabbing and/or lifting event. The yolk-receiving chamber preferably comprises a smooth surface coextensive with the cylindrical inner surface thereby together forming smooth inner yolk displacement surfacing for preventing rupture of the vitelline membrane during egg yolk displacements.

In addition to the various structural aspects of the invention, it is believed that the foregoing specifications further support certain egg moving methodological advancements or certain methods for moving an egg yolk. Accordingly, the method for moving an egg supported by the device according to the present invention is believed to essentially comprise the steps of: sucking an egg yolk into an egg-receiving structure via a suction force in a first direction away from a first location; and displacing the egg-receiving structure with the egg yolk contained therein to a second location.

The method may further comprise the step of directing the egg yolk in a second direction within the egg-receiving structure after sucking the egg yolk into the egg-receiving structure in the first direction. The step of directing the egg yolk in the second direction within the egg-receiving structure may be defined by comprising the step of chamber-receiving the egg yolk in a direction radial to the first direction. The step of directing the egg yolk in the second direction may preferably comprise the step of gravitationally forcing the egg yolk in the direction radial to the first direction.

Accordingly, although the invention has been described by reference to certain preferred embodiments and certain methodologies, it is not intended that the novel arrangement and methods be limited thereby, but that modifications thereof are intended to be included as falling within the broad scope and spirit of the foregoing disclosures and the appended drawings.

1. An egg yolk separator device for separating an intact egg yolk from an egg albumen, the egg yolk separator device comprising:
suction means for selectively providing a suction force; and
a yolk-receiving structure, the yolk-receiving structure having a tubular construction, a yolk inlet-outlet orifice, and an inner yolk-receiving chamber, the tubular construction having a tubular axis, the yolk-receiving chamber extending radially from the tubular axis for receiving and supporting the egg yolk in radial adjacency to the tubular axis, the yolk-receiving structure being coupled to the suction means such that the selectively provided suction force is directed away from the yolk inlet-outlet orifice toward the suction means, the orifice being sized and shaped to receive an egg yolk having a yolk weight, a vitelline membrane and membrane-contained cytoplasm, the suction force being greater than the yolk weight for directing the egg yolk into the yolk-receiving structure via the yolk inlet-outlet orifice.

2. The egg yolk separator device of claim 1 wherein the suction means are defined by a suction bulb, the suction bulb being constructed from an elastomeric material and defining an inner volumetric space, the suction bulb being compressible to an actuated state for decreasing the inner volumetric space and elastically restorable to a relaxed state for re-defining the inner volumetric space, the elastically restorabililty of the suction bulb for creating the suction force and directing the egg yolk into the yolk-receiving structure via the yolk inlet-outlet orifice.

3. The egg yolk separator device of claim 2 wherein the suction bulb comprises a main body and a circumferential band structure, the band structure having a relatively higher spring constant than the main body for providing the user with means for differing the suction force upon the egg yolk.

4. The egg yolk separator device of claim 2 wherein the suction bulb comprises a flattened outer surface, the flattened outer surface extending in a plane parallel to the tubular axis and orthogonal to the radial direction of the yolk-receiving chamber.

5. The egg yolk separator device of claim 1 wherein the yolk inlet-outlet orifice comprises a rounded outer terminus, the rounded outer terminus for preventing inadvertent rupture of the egg yolk.

6. The egg yolk separator device of claim 1 wherein the yolk-receiving structure comprises a cylindrical inner surface, the cylindrical inner surface for reducing stress on the vitelline membrane and thus for preventing inadvertent rupture of the egg yolk.

7. The egg yolk separator device of claim 6 wherein the yolk-receiving chamber comprises a smooth surface coextensive with the cylindrical inner surface thereby together forming smooth inner yolk displacement surfacing for preventing rupture of the vitelline membrane during egg yolk displacements.

8. The egg yolk separator device of claim 1 wherein the yolk-receiving structure is removably and threadably coupled to the suction means, the removably and threadably coupled yolk-receiving structure being removable for enabling interchangeability of components with the suction means.

9. A device for grabbing an egg yolk, said device comprising:
suction means for selectively providing a suction force; and
a yolk-receiving structure, the yolk-receiving structure comprising an inlet-outlet orifice, a cylindrical axis, and an inner yolk-receiving chamber, the yolk-receiving structure being coupled to said suction means such that the selectively provided suction force is directed away from the inlet-outlet orifice toward the suction means, the inlet-outlet orifice being sized and shaped to receive an egg yolk having a yolk weight, the suction force being greater than the yolk weight for directing the egg yolk into the yolk-receiving structure via the yolk inlet-outlet orifice, the yolk-receiving chamber extending radially from the cylindrical axis for receiving and supporting the egg yolk in radial adjacency to the cylindrical axis.

10. The device of claim 9 wherein the suction means are defined by a suction bulb, the suction bulb comprising a main body and a circumferential band structure, the band structure having a relatively higher spring constant than the main body for providing the user with means for differing the suction force upon the egg yolk.

11. The device of claim 9 wherein the inlet-outlet orifice comprises a rounded outer terminus, the rounded outer terminus for preventing inadvertent rupture of the egg yolk during a grabbing event.

12. The device of claim 9 wherein the yolk-receiving structure comprises a cylindrical inner surface, the cylindrical inner surface being radially equidistant from the cylindrical axis, the cylindrical inner surface for reducing stress on the vitelline membrane and thus for preventing inadvertent rupture of the egg yolk.

13. (canceled)

14. The device of claim 12 wherein the suction means comprises a flattened outer surface, the flattened outer surface extending in a plane parallel to orthogonal to the cylindrical axis for preventing the device from rolling upon a support surface.

15. The device of claim 13 wherein the yolk-receiving chamber comprises a smooth surface coextensive with the cylindrical inner surface thereby together forming smooth inner yolk displacement surfacing for preventing rupture of the vitelline membrane during egg yolk displacements.

16. The device of claim 9 wherein the yolk-receiving structure is removably and threadably coupled to the suction means, the removably and threadably coupled yolk-receiving structure being removable for enabling interchangeability of components with the suction means.

17. A method for moving an intact egg yolk, the method comprising the steps of:
sucking an intact egg yolk into an egg-receiving structure via a suction force in a first direction away from a first location;
displacing the egg-receiving structure with the intact egg yolk contained therein to a second location; and
directing the intact egg yolk in a second direction within the egg-receiving structure after sucking the intact egg yolk into the egg-receiving structure in the first direction.

18. (canceled)

19. The method of claim 17 wherein the step of directing the intact egg yolk in the second direction within the egg-receiving structure comprises the step of chamber-receiving the intact egg yolk in the second direction radial to the first direction.

20. The method of claim 19 wherein the step of directing the intact egg yolk in the second direction comprises the step of gravitationally forcing the intact egg yolk in the second direction radial to the first direction.
